(19) United States
(12) Patent Application Publication
(10) Pub. No.: US 2024/0004527 A1
(43) Pub. Date: Jan. 4, 2024

(54) SYSTEMS AND METHODS FOR PROVIDING CUSTOM FILTERS

(71) Applicants: Atlassian Pty Ltd., Sydney (AU); Atlassian Inc., San Francisco, CA (US)

(72) Inventor: Beven Lee, Sydney (AU)

(21) Appl. No.: 17/855,482

(22) Filed: Jun. 30, 2022

(51) Int. Cl. G06F 3/0484; G06F 9/451; G06F 16/2455; G06F 21/62

(52) U.S. Cl. CPC G06F 3/0484; G06F 9/451; G06F 16/24552; G06F 21/6227

(57) ABSTRACT

Systems, methods, and computer readable media for managing custom filters are disclosed. The method includes receiving a request for custom filters, from a user device, for a user interface displayed on the user device, the request including an identifier of the user interface displayed on the user device. The method further comprises retrieving from a data store custom filter data for one or more custom filters associated with the user interface using the identifier of the user interface. The custom filter data for each custom filter includes a filter identifier and a filter query. The method further includes communicating the one or more custom filters to the user device, the user device displaying the one or more custom filters on the user interface and storing the custom filters in a local cache maintained on the user device.

### TECHNICAL FIELD

The present disclosure relates in general to the field of object tracking systems, and in particular, to improved user interfaces for object tracking systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Object tracking systems help organizations manage projects and tasks in an efficient and intelligent manner Typically such systems display user interfaces that help users segment projects into individual tasks and visualize these individual tasks in a logical manner. It has been shown that such systems help streamline project management, ensure tasks are performed in a timely manner, and projects are executed smoothly.

However, as the complexity of project and team sizes increase, the number of individual tasks displayed on the user interface also increase—often to a degree that begins to negatively affect some of the advantages offered by these object tracking systems.

### SUMMARY

In certain embodiments of the present disclosure a computer-implemented method for retrieving one or more custom filters. The method includes receiving a request for custom filters, from a user device, for a user interface displayed on the user device. The request includes an identifier of the user interface displayed on the user device. The method further comprises retrieving from a data store custom filter data for one or more custom filters associated with the user interface using the identifier of the user interface. The custom filter data for each custom filter includes a filter identifier and a filter query. The method further includes communicating the one or more custom filters to the user device, the user device displaying the one or more custom filters on the user interface and storing the custom filters in a local cache maintained on the user device.

Other example embodiments described herein are directed to a system for retrieving one or more custom filters. The system includes a processing unit, a communication interface, and a non-transitory computer-readable storage media. The storage media comprising instructions which, when executed by the processing unit, cause the processing unit to receive a request for custom filters, from a user device, for a user interface displayed on the user device. The request includes an identifier of the user interface displayed on the user device. The storage media further comprising instructions which, when executed by the processing unit, cause the processing unit to retrieve from a data store custom filter data for one or more custom filters associated with the user interface using the identifier of the user interface. The custom filter data for each custom filter includes a filter identifier and a filter query. The storage media further still comprising instructions which, when executed by the processing unit, cause the processing unit to communicate the one or more custom filters to the user device, the user device displaying the one or more custom filters on the user interface and storing the custom filters in a local cache maintained on the user device.

In certain other embodiments of the present disclosure a non-transitory computer readable medium for retrieving custom filters is disclosed. The non-transitory computer readable medium includes instructions, which when executed by a processing unit of a computer processing system, cause the computer processing system to perform the method described above.

### BRIEF DESCRIPTION OF THE DRAWINGS

In the drawings:

FIG. 1 is an example virtual board rendered by a client system.

FIG. 2 is a block diagram of a networked environment according to some embodiments of the present disclosure.

FIG. 3 is a block diagram of a computer processing system with which various embodiments of the present disclosure may be implemented.

FIG. 4 is a flowchart illustrating an example method for creating a custom filter according to some embodiments of the present disclosure.

FIG. 5 is a flowchart illustrating an example method for updating a custom filter according to some embodiments of the present disclosure.

FIG. 6 is a flowchart illustrating a method for deleting a custom filter according to some embodiments of the present disclosure.

FIG. 7 is a flowchart illustrating an example method for retrieving one or more custom filters according to some embodiments of the present disclosure.

FIG. 8 is a flowchart illustrating a method for applying one or more custom filters when a UI is first loaded according to some embodiments of the present disclosure.

FIG. 9 is a flowchart illustrating a method for applying a custom filter to a displayed UI according to some embodiments of the present disclosure.

FIG. 10 is an example screenshot displaying a custom filter interface according to some embodiments of the present disclosure.

FIG. 11 is an example virtual board rendered by a client system according to some embodiments of the present disclosure.

While various embodiments described in the present disclosure are amenable to various modifications and alternative forms, specific embodiments are shown by way of example in the drawings and are described in detail. It should be understood, however, that the drawings and detailed description are not intended to limit the scope of the embodiments described herein to the particular form disclosed, but to cover all modifications, equivalents, and alternatives falling within the spirit and scope of the embodiments as defined by the appended claims.

### DETAILED DESCRIPTION

In the following description, for the purposes of explanation, numerous specific details are set forth in order to provide a thorough understanding of the embodiments described herein. It will be apparent, however, that the embodiments described herein may be practiced without these specific details. In some instances, well-known structures and devices are shown in block diagram form in order to avoid unnecessary obscuring.

### Overview

Aspects of the present disclosure will be described with respect to user interfaces associated with object tracking applications that provide mechanisms for creating objects, object states, and transitioning objects between states. However, it will be appreciated that this is just an example and that aspects of the present disclosure can be implemented for other types of user interfaces just as easily without departing from the scope of the present disclosure. Various aspects/embodiments described herein provide improved object tracking system interfaces that can help users manage the number of individual tasks displayed on the user interface to a manageable level.

One example of an object tracking application (as referred to in the present context) is Trello. Trello allows users to create objects in the form of tasks and object states in the form of lists. In order to change a task state in Trello a task is moved from one list to another. For example, a Trello user may set up a project having the lists “To Do,” “In Progress,” and “Completed.” A user may then create tasks that need to be done and adds them to the “To Do” list: e.g., a “grocery shopping” task, a “washing up” task, an “organize house party” task etc. The user can also transition tasks between lists, e.g., by dragging or other means, from its current list to another one. For example, once the user has completed grocery shopping they can move the corresponding task from the “To Do” list to the “Completed” list. If the user has started but not yet completed work on their house party task they can move the corresponding task from the “To Do” list to the “In Progress” list.

A further example of what the present disclosure refers to as an object tracking application is Jira. Jira allows users to create objects in various forms—for example issues or, more generally, work items. A work item in Jira is an object with associated information and an associated workflow—e.g., a series of states through which the work item transitions over its lifecycle. Any desired workflow maybe defined for a given type of work item.

Object tracking applications such as those described above often provide user interfaces for displaying the current state of objects maintained by the application and allowing users to move objects (e.g., tasks in Trello, work items in Jira) between states (or lists). In both Trello and Jira such user interfaces are referred to as backlogs or virtual boards. A backlog typically is a tool for workflow visualization that displays pending tasks as a list. A backlog is typically arranged such that most important tasks are displayed at the top, while those at the bottom of the list are less important tasks that might never get done. An example of a backlog UI is one used at airports to display a list to flights to depart from the airport and/or arrive at the airport arranged based on time. A virtual board (also interchangeably referred to as a board herein) is also a tool for workflow visualization, but boards include cards, columns, and/or swimlanes to visualize workflows in an effective manner Each card in the board may be a visual representation of an object (e.g., task in Trello, work item in Jira) and may include information about the object, such as deadlines, assignee, description, etc. Each column in the board represents a different state (e.g., stage of a workflow in Jira or a list in Trello). The cards typically progress through the columns until their completion. Swimlanes are horizontal lanes that can be used to separate different activities, teams, classes or services, etc.

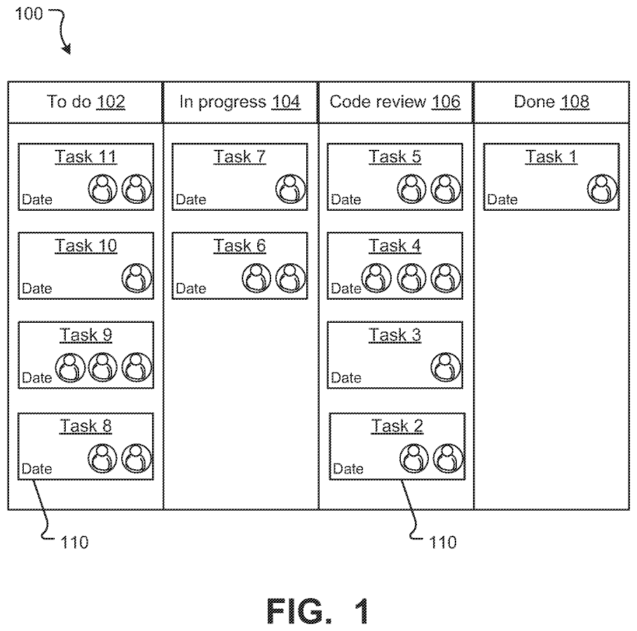

FIG. 1 provides an example virtual board 100 which shows a workflow to track software development projects. In particular, the board 100 includes four columns, each corresponding to a workflow state: TO DO 102; IN PROGRESS 104; CODE REVIEW 106; and DONE 108. Board 100 also includes several cards 110, i.e., visual representations of objects (tasks in the present context), each of which is in a particular column according to the current state of the object. Each card may include information about the underlying object—e.g., it may include an object title and description, a date by which the object is to be completed or was completed and one or more user assigned to complete the object.

For simplicity, board 100 is shown with a limited number of cards. However, often, backlogs and boards related to large projects can be very large, including hundreds if not thousands of objects/cards. In such cases, it is often difficult for users to quickly find objects they need to complete without leaving the displayed user interface. Some software applications that provide backlogs and boards may provide standard or hardcoded filtering options. However, these standard filters may not filter the displayed objects in a manner required by the user. Another options may be to utilize advanced search capabilities offered by the software application. This option may allow users to write queries to find and filter specific objects. However, this solution is also not ideal. It requires navigation to an advance search page and results in a disruptive, context-switching experience. In addition, many users may struggle to create queries in the query language associated with the software language. All this adds to the user's cognitive burden.

Aspects of the present disclosure address one or more of these issues. That is, aspects of the present disclosure provide users with the ability to quickly find objects they are looking for in object tracking user interface (UI) such as a board or a backlog without having to leave the context of the UI. In particular, aspects of the present disclosure provide the ability to create and save custom filters that can be applied to object tracking UIs when they are loaded or when selected by users.

Generally speaking, filters provide a set of controls to reduce items displayed on a UI based on attributes the user is interested in. Custom filters as used herein are filters that can be created (based on any specific attributes of the displayed objects) and saved by users. Once a custom filter is created, it can be applied to an object tracking UI whenever the user is viewing the UI. If any other predefined or standard filters are already applied to reduce the objects displayed on the UI, the application of the custom filter may further reduce the displayed items. Generally speaking, a custom filter will have a filter name and an associated filter query. Users can select any such custom filter when viewing an object tracking UI and the presently disclosed systems and methods will filter the UI based on the filter query associated with the selected custom filter—i.e., the presently disclosed systems and methods will only show objects in the UI that match the filter query associated with the selected custom filter.

These and other features and advantages of the present disclosure will be described in the following sections.

### Example Systems

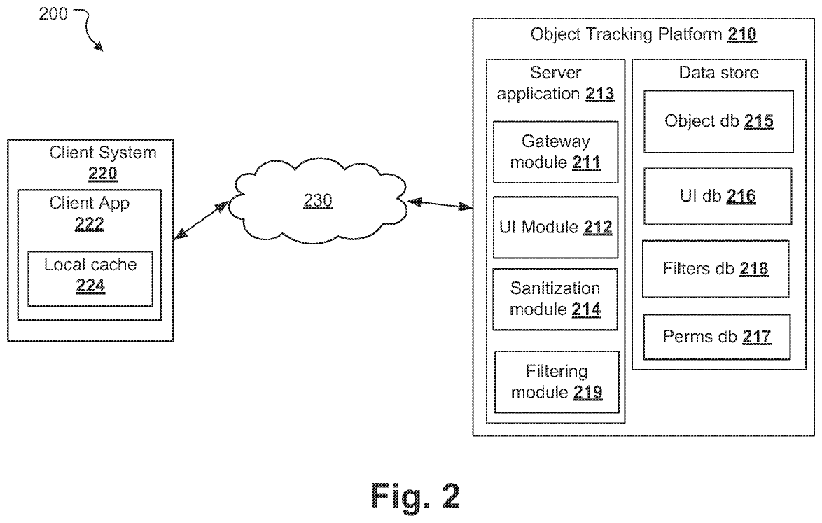

FIG. 2 illustrates a networked environment 200 in which one or more aspects of the present disclosure are implemented. Specifically, FIG. 2 illustrates the various systems involved in providing custom filters according to embodiments of the present disclosure. The networked environment 200 includes an object tracking platform 210 and a client system 220.

Generally speaking, the object tracking platform 210 may be a computer processing system or set of computer processing systems configured to provide an object tracking application used (inter alia) to create, manage, and track objects. Object tracking platform 210 may, however, provide other services/perform other operations. In order to provide such services/operations, the object tracking platform 210 includes a server application 213 and a main data store.

The server application 213 is executed by one or more computer processing systems to provide server-side functionality to a corresponding client application (e.g., client application 222 as discussed below). In one example, the server application 213 is configured to cause display of an object tracking UI (e.g., virtual board 100) on a client system 220. Further, the server application 213 is configured to receive data requests from client systems 220 to load or update object tracking UIs and responds to these data requests. For example, when the server application 213 receives a request to load an object tracking UI, it may respond with data defining the structure (e.g., styling information), content (e.g., the actual data to be displayed on the web page), and behavior (e.g., interactive components) of the object tracking UI. Further, the server application 213 may be configured to receive data update instructions from the client systems 220 (e.g., to add a new card to a virtual board, move a card from one column to another, delete a card on a virtual board, add or delete a column of the virtual board, etc.) and may be configured to perform actions based on these instructions, e.g., it may update the main data store based on the received data update instructions. In addition to the above, the server application 213 may also receive requests to create, update or delete custom filters for a board from the client system 220 and receive requests to retrieve filter data and apply a selected custom filter.

The server application 213 comprises one or more application modules, libraries, APIs or other software elements that implement the above-described features and functions. For example, the server application 213 includes a gateway module 211 that acts as a gateway between the client systems 220 and the object tracking platform 210 and passes requests received from the client systems 220 to one or more application modules. The server application 213 further includes a UI module 212 that may manage UI configuration. That is, for every UI (e.g., board or backlog) maintained by the object tracking platform 210, the UI module 212 maintains UI data and performs functions such as retrieving UI data for one or more queried UI identifiers and updating UI data. In addition, the UI module 212 may be configured to maintain custom filter data in association with UIs and perform functions such as creating, updating, or deleting custom filters. The UI module 212 is also configured to retrieve custom filters for one or more queried UI identifiers.

In addition to these modules, the server application 213 may include a sanitization module 214 that ensures any private data present in custom filter queries is not displayed to users that do not have permission to view this data and filtering module 219 that is configured to apply one or more custom filters to data displayed in an object tracking UI, perform a search based on a selected custom filter, and communicate the filtered results to the gateway module 211.

Where the client application 222 is a web browser, the server application 213 may be a web server such as Apache, IIS, nginx, GWS, or an alternative web server. Where the client application 222 is a specific/native application, server application 213 may be an application server configured specifically to interact with that client application 222. In some embodiments, the server application 213 may be provided with both web server and application server applications.

The main data store includes one or more database management systems (DBMS) and one or more databases 215, 216, 217, 218 (operating on one or multiple computer processing systems). Generally speaking, the DBMS receives queries from a given system (e.g., server application 213), interacts with the one or more databases 215, 216, 217, 218 to read/write data as required by those queries, and responds to the relevant system with results of the query.

The data store may store any data relevant to the services provided/operations performed by the server application 213. By way of a specific example, the data store stores an object database 215, a UI database 216, a filters database 217, and a permissions database 218.

The object database 215 stores data related to objects (e.g., tasks or issues) that are maintained and managed by the object tracking platform 210. In this case, various data can be maintained in respect of a given object, for example: an object identifier; an object state; a team or individual to which the object has been assigned; an object description; an object severity; a service level agreement associated with the object; a tenant to which the object relates; an identifier of a creator of the object; a project to which the object relates; identifiers of one or more objects (parent objects) that the object is dependent on; identifiers of one or more objects (children objects) that depend on the object; identifiers of one or more other stakeholders; and/or other data.

Data for an object may be stored across multiple database records (e.g., across multiple database tables) that are related to one another by one or more database keys (for example object identifiers and/or other identifiers).

The UI database 216 stores data related to object tracking UIs maintained by the platform 210. In case the UI database maintains data related to virtual boards, the data includes, e.g., for each virtual board, a board identifier, a board name, a board description, a creator of a board, number of columns in the board, number of swimlanes in the board, names of columns and/or swimlanes in the board, a list of objects that are part of the board and a list of assignees associated with those objects. As used herein, such board data is referred to as board state data. The board state data may be stored in one or more tables or storage devices as board state records, where each record corresponds to a given board.

The filters database 217 stores custom filters created by users of the client systems 220. In one example, the filters database 217, stores filter names and corresponding filter queries. Further, optionally, it may store a description for the filter. In certain examples, custom filters may be created at the UI level—i.e., an administrator of a UI may create custom filters. Each user associated with that UI may then see all the custom filters created by the administrator (provided the users have permission to see the filters). In this case, for each filter record, the filter database 217 stores the UI identifier of the UI the filter is associated with. In other examples, each user may be able to set personalized custom filters for themselves. In this case, different users of the same UI may create and maintain different custom filters. In this case, for each filter record, the filter database 217 stores the UI identifier of the UI the filter is associated with and the user identifier of the user the filter is associated with.

The object tracking platform 210 may host a permission based application—that is, at least some data hosted by the object tracking platform 210 may have restricted access. In some examples, the platform 210 utilizes role based access control or permissions for such data. For instance, it may have three classes of permissions—global, project and object permissions. Global permissions allows users to access all data maintained by the server application 213. Project permissions allow or restrict users from accessing data associated with a particular project created in the object tracking application and object permissions allow or restrict users from accessing a specific object within a project. Further, for each class, permissions may be further configurable. For example, a role may have permission to view a given project, but may not have permission to create, delete, or edit objects in that project. Similarly, another role may be able to perform all these actions in a given project, but may not be allowed to edit the workflow or column structure in the object tracking UI for the project.

The permissions database 218 is configured to maintain such permission data for the object tracking platform 210. That is, the permissions database 218 maintains records of permissions associated with individual objects available in the object database 215. Further, the permissions database 218 is configured to receive permission check queries for one or more user identifiers from other systems (e.g., the server application 213 and in particular the UI module 212), check whether the given user identifier has permission to access the one or more requested data resources (e.g., a board, a card displayed in a board, a filter), and return a response to the permission check query.

Although the various databases 215, 216, 217, and 218 are depicted as being part of the main data store, these databases may be maintained as in-memory caches. Further, one or more of these databases may be maintained as separate entities with their own DBMS. For example, the permissions database 218 may be an independent permissions system that not only stores permission data for the object tracking platform 210 but may also store permission data for other product applications.

The systems of the object tracking platform 210 typically execute on multiple computer processing systems. For example, in some implementations each component of the object tracking platform 210 may be executed on a separate computer processing system. In other embodiments, multiple (or even all) components of the object tracking platform 210 may run on a single computer processing system. In certain cases a clustered server architecture may be used where applications are executed across multiple computing instances (or nodes) that are commissioned/decommissioned on one or more computer processing systems to meet system demand. For example, the UI module 212 may be implemented as multiple nodes connected to the gateway module 211 via a load balancer.

Client system 220 may be any computer processing system which is configured (or configurable) by hardware and/or software to offer client-side functionality. By way of example, suitable client systems may include: server computer systems, desktop computers, laptop computers, netbook computers, tablet computing devices, mobile/smart phones, and/or other computer processing systems.

Client system 220 hosts a client application 222 which, when executed by the client system 220, configures the client system 220 to provide client-side functionality. This may include, for example, interacting with (i.e., sending data to and receiving data from) server application 213. Such interactions typically involve logging on (or otherwise accessing) server application 213 by providing credentials for a valid account maintained by the object tracking platform 210. As noted above, in certain embodiments the account may be associated with a particular tenant identifier. Once validated, a user can perform various functions using client application 222, for example requesting web pages, generating requests to read data from or write data to the main data store, automating such requests (e.g., setting requests to periodically execute at certain times), and other functions.

The client application 222 may also maintain a local cache 224 while the client application 222 is being executed. The local cache 224 may store data about the object tracking UI being displayed on the user device, including data about the objects being displayed in the UI, the custom filters applied to the objects and in some embodiments even data about the custom filters available for one or more object tracking UIs. In some embodiments, the local cache 224 is temporarily stored while the client application displays one or more object tracking UIs and may be flushed when the corresponding object tracking UIs are closed or refreshed or the client 222 is closed.

Client application 222 may be a general web browser application (such as Chrome, Safari, Internet Explorer, Opera, or an alternative web browser application) which accesses a server application such as server application 213 via an appropriate uniform resource locator (URL) and communicates with the server application via general world-wide-web protocols (e.g., HTTP, HTTPS, FTP). Additionally, or altenatively, the client application 222 may be a native application programmed to communicate with server application 213 using defined application programming interface (API) calls. When the client application 222 is a web browser, its main function is to present web resources requested by the user. Further, a given client system 220 may have more than one client application 222, for example it may have two or more types of web browsers.

The systems 210-220 depicted in FIG. 2 communicate with each other over a communication network 230. Communications network 230 may be a local area network, public network (e.g., the Internet), or a combination of both.

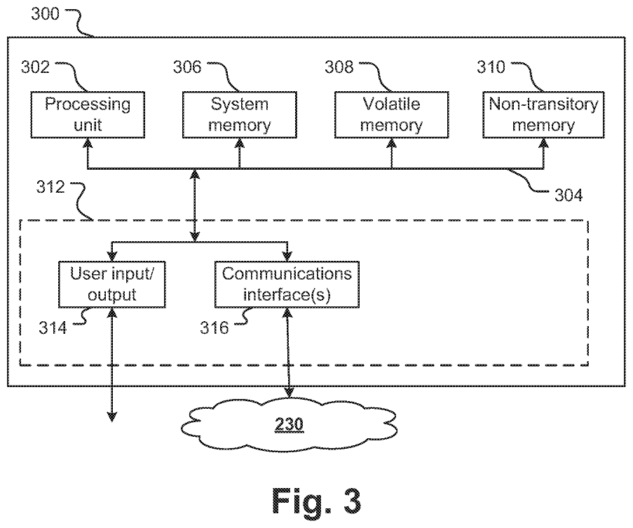

FIG. 3 provides a block diagram of a computer processing system 300 configurable to implement embodiments and/or features described herein. System 300 is a general purpose computer processing system. It will be appreciated that FIG. 3 does not illustrate all functional or physical components of a computer processing system. For example, no power supply or power supply interface has been depicted, however system 300 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 300 includes at least one processing unit 302—for example a general or central processing unit, a graphics processing unit, or an alternative computational device). Computer processing system 300 may include a plurality of computer processing units. In some instances, where a computer processing system 300 is described as performing an operation or function all processing required to perform that operation or function will be performed by processing unit 302. In other instances, processing required to perform that operation or function may also be performed by remote processing devices accessible to and useable by (either in a shared or dedicated manner) system 300.

Through a communications bus 304, processing unit 302 is in data communication with a one or more computer readable storage devices which store instructions and/or data for controlling operation of the processing system 300. In this example system 300 includes a system memory 306 (e.g., a BIOS), volatile memory 308 (e.g., random access memory such as one or more DRAM applications), and non-volatile (or non-transitory) memory 310 (e.g., one or more hard disks, solid state drives, or other non-transitory computer readable media). Such memory devices may also be referred to as computer readable storage media (or a computer readable medium).

System 300 also includes one or more interfaces, indicated generally by 312, via which system 300 interfaces with various devices and/or networks. Generally speaking, other devices may be integral with system 300, or may be separate. Where a device is separate from system 300, connection between the device and system 300 may be via wired or wireless hardware and communication protocols, and may be a direct or an indirect (e.g., networked) connection.

Wired connection with other devices/networks may be by any appropriate standard or proprietary hardware and connectivity protocols, for example Universal Serial Bus (USB), eSATA, Thunderbolt, Ethernet, HDMI, and/or any other wired connection hardware/connectivity protocol.

Wireless connection with other devices/networks may similarly be by any appropriate standard or proprietary hardware and communications protocols, for example infrared, BlueTooth, Wi-Fi; near field communications (NFC); Global System for Mobile Communications (GSM), Enhanced Data GSM Environment (EDGE), long term evolution (LTE), code division multiple access (CDMA—and/or variants thereof), and/or any other wireless hardware/connectivity protocol.

Generally speaking, and depending on the particular system in question, devices to which system 300 connects—whether by wired or wireless means—include one or more input/output devices (indicated generally by input/output device interface 314). Input devices are used to input data into system 300 for processing by the processing unit 302. Output devices allow data to be output by system 300. Example input/output devices are described below, however it will be appreciated that not all computer processing systems will include all mentioned devices, and that additional and alternative devices to those mentioned may well be used.

For example, system 300 may include or connect to one or more input devices by which information/data is input into (received by) system 300. Such input devices may include keyboards, mice, trackpads (and/or other touch/contact sensing devices, including touch screen displays), microphones, accelerometers, proximity sensors, GPS devices, touch sensors, and/or other input devices. System 300 may also include or connect to one or more output devices controlled by system 300 to output information. Such output devices may include devices such as displays (e.g., cathode ray tube displays, liquid crystal displays, light emitting diode displays, plasma displays, touch screen displays), speakers, vibration applications, light emitting diodes/other lights, and other output devices. System 300 may also include or connect to devices which may act as both input and output devices, for example memory devices/computer readable media (e.g., hard drives, solid state drives, disk drives, compact flash cards, SD cards, and other memory/computer readable media devices) which system 300 can read data from and/or write data to, and touch screen displays which can both display (output) data and receive touch signals (input).

System 300 also includes one or more communications interfaces 316 for communication with a network, such as network 230 of environment 200. Via a communications interface 316 system 300 can communicate data to and receive data from networked devices, which may themselves be other computer processing systems.

System 300 may be any suitable computer processing system, for example, a server computer system, a desktop computer, a laptop computer, a netbook computer, a tablet computing device, a mobile/smart phone, a personal digital assistant, or an alternative computer processing system.

System 300 stores or has access to computer applications (also referred to as software or programs)—e.g., computer readable instructions and data which, when executed by the processing unit 302, configure system 300 to receive, process, and output data. Instructions and data can be stored on non-transitory computer readable media accessible to system 300. For example, instructions and data may be stored on non-transitory memory 310. Instructions and data may be transmitted to/received by system 300 via a data signal in a transmission channel enabled (for example) by a wired or wireless network connection over interface such as 312.

Applications accessible to system 300 will typically include an operating system application such as Microsoft Windows™, Apple macOS™, Apple iOS™, Android™ Unix™, or Linux™.

System 300 also stores or has access to applications which, when executed by the processing unit 302, configure system 300 to perform various computer-implemented processing operations described herein. For example, and referring to networked environment 200 of FIG. 2 above, client system 220 includes a client application 222 which configures the client system 220 to perform client system operations, and object tracking platform 210 includes server application 213 which configures the server environment computer processing system(s) to perform the described server environment operations.

In some cases part or all of a given computer-implemented method will be performed by a single computer processing system 300, while in other cases processing may be performed by multiple computer processing systems in data communication with each other.

### Example Methods

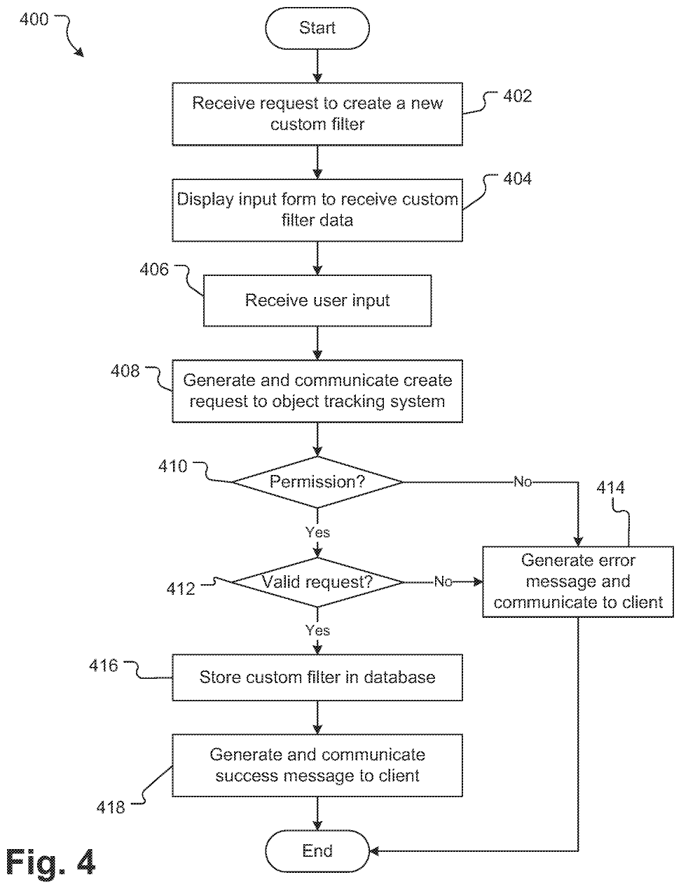

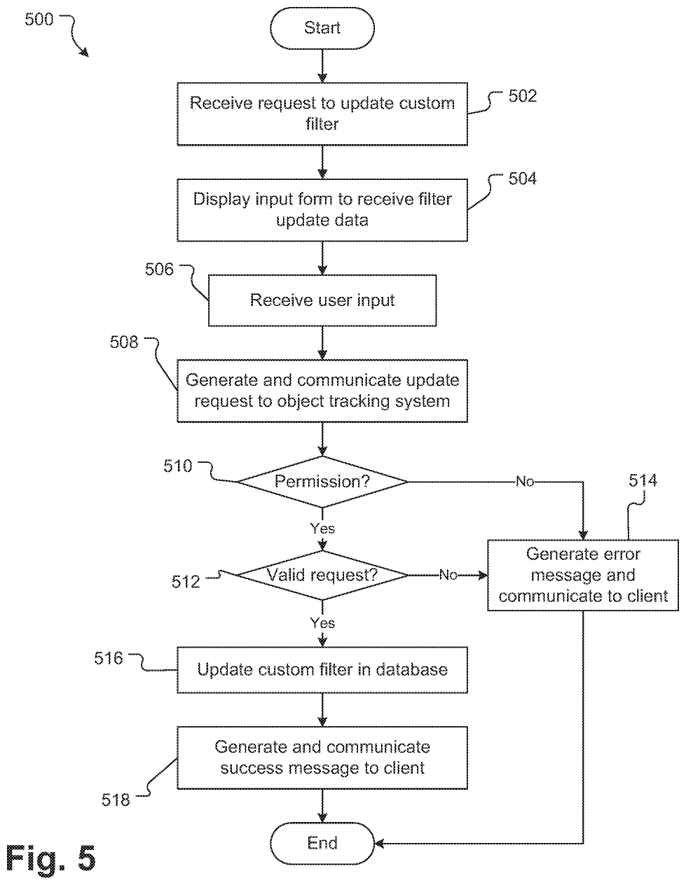

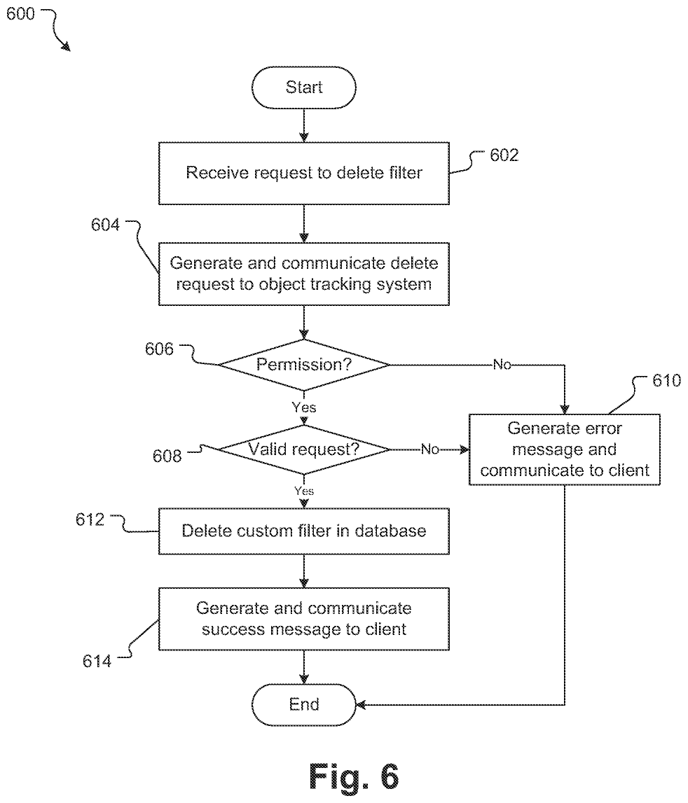

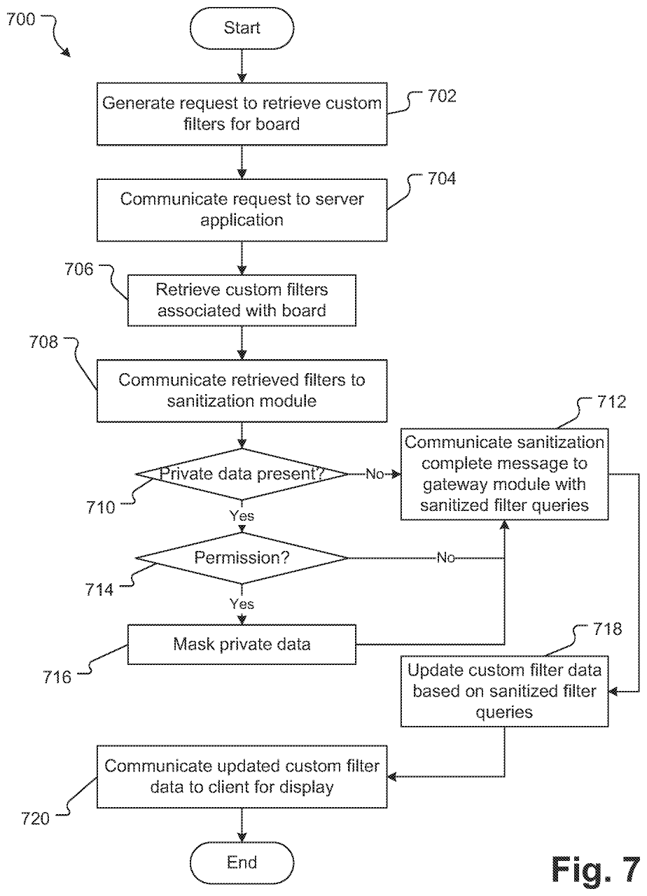

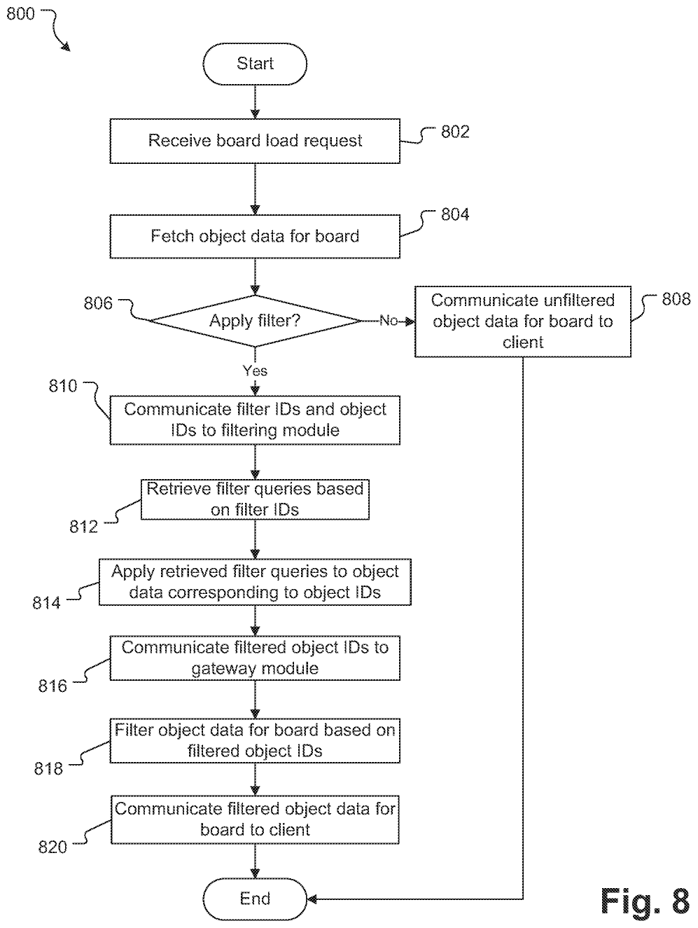

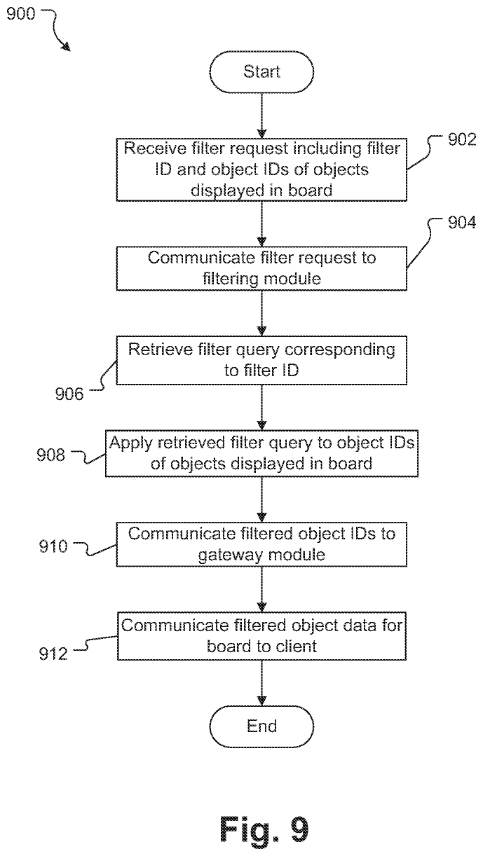

Various methods and processes for creating, updating, deleting, loading, and applying custom filters will now be described. In particular, FIG. 4 illustrates an example process for creating a custom filter, FIG. 5 illustrates an example process for updating a custom filter, FIG. 6 illustrates an example process for deleting a custom filter, FIG. 7 illustrates an example process for loading custom filters, and FIGS. 8-9 illustrate two example processes for applying custom filters according to aspects of the present disclosure. Further, the methods disclosed herein will be described with reference to an example object tracking UI—a virtual board. It will be appreciated that this is done for simplicity and does not by any means restrict the presently disclosed methods to virtual boards. Instead, the presently disclosed methods can be equally applied to other types of object tracking UIs including backlogs. In line with the virtual board example, the UI module 212 may be interchangeably referred to as a board module 212 and the UI database 216 may be interchangeably referred to as a board database 216 when describing these methods.

Although method 400 is described with reference to a single custom filter creation request, it will be appreciated that in practice this method is repeated for every custom filter creation request.

In some embodiments, custom filters may be created, updated and/or deleted by special users, e.g., administrator of a corresponding board, but may be applied by all users that have permission to view the board. In other embodiments, any user that has permission to view the board may have permission to create, update, and/or delete a custom filter. In case only special users are allowed to create custom filters, custom filters are created for the board and associated with the board. In such cases, all users that have permission to view the board can view and/or apply custom filters to the board. However, they may not be allowed to update or delete filter. On the other hand, if any user (who may not be an administrator) is allowed to create custom filters, custom filters can be created for that user and board combination such that only the user that created the custom filter will be able to view the filter. In this case, the user that created the custom filter will also have permission to update and/or delete the custom filter.

In processes 400-600, it is presumed that only special users have permission to create, update or delete custom filters and that the same custom filters are available for all users of a given board. However, it will be appreciated that this is merely an example and that in other examples, processes 400-600 can be performed in circumstances where any user that has permission to view a board can create, update, or delete custom filters.

### Create Custom Filter

Generally speaking, an administrator may wish to create a new custom filter for a board. This may happen, e.g., because the administrator has just created a board for a new project and has one or more custom filters in mind for the board. In another example, the administrator may be viewing a board and may have an idea for a new custom filter that may greatly help reduce the clutter on that board. In still other cases, other users that can view the board may have one or more ideas for custom filters that may aid users viewing the board and these users may request the administrator to create custom filters based on these ideas.

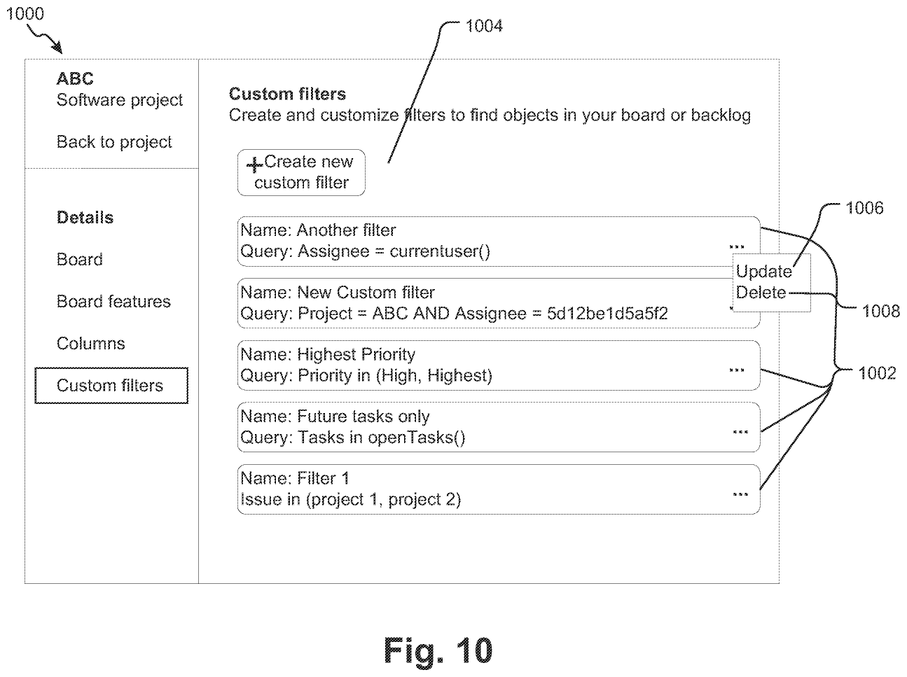

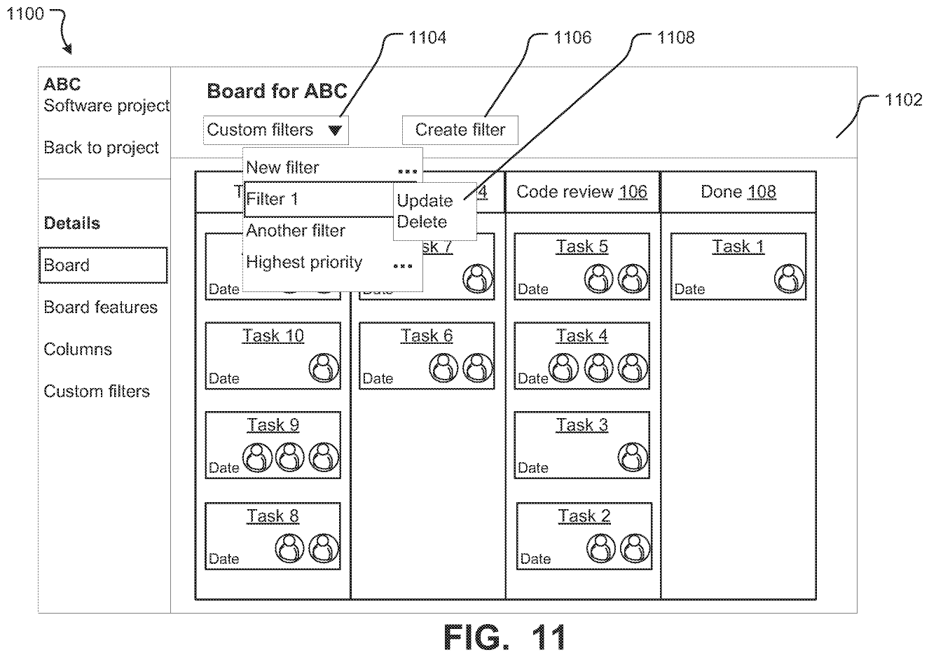

In any event, method 400 commences at step 402 where the client application 222 receives a request to create a new custom filter. In one example, when the client application 222 is opened or executed on the client system it communicates with the object tracking platform 210 to receive a webpage or landing page for rendering on the client system 220. The page may include links to one or more active boards the user has permission to view. Further for each board, the page may include links to further pages or interfaces that display information associated with the board such as board features, columns and statuses, and custom filters. When the user selects the custom filters link, the user may be taken to a custom filters page that shows a list of custom filters that are saved for the corresponding board. This custom filter page may further include an interactive control to add a new custom filter. FIG. 10 shows an example custom filters page 1000. The page 1000 includes a list of custom filters 1002 and an interactive affordance 1004 to create a new filter. In another example, the user may be on a board UI, such as the UI 1100 shown in FIG. 11, which may include a top or side ribbon 1102 including a display element 1104 that shows one or more custom filters associated with the board and an interactive control 1106 to create a new filter. The interactive control 1004 or 1106 may displays keywords such as “create filter,” “new filter,” or just a “+” symbol. In some examples, such interactive controls may only be displayed on the custom filter page 1000 or the board UI 1100 if the viewing user has permission to create filters. If the viewing user does not have permission to create custom filters, the client application 222 may refrain from displaying such interactive controls or may disable the interactivity of these controls.

At step 402, the client application 222 receives user input on an interactive control associated with creating a new custom filter.

The method then proceeds to step 404, where the client application 222 displays an input form to receive custom filter data from the user. In certain embodiments, the user creating the custom filter may be requested to provide the following information about the custom filter in the displayed form—a filter name and a filter query. Optionally, the input form may include a field where the user can provide a description of the custom filter. In some examples, the input form may include a query builder or wizard that aids the user to create the filter query. For example, the input form may include one or more drop-down menus or autocomplete functionalities that help the user select proper query syntax. Consider the example of the custom filter “Another filter” shown in FIG. 10. In some examples, when the user had started inputting the query string for that filter in the input form and initially typed Assignee=, the query builder or wizard may provide a drop down menu including potential assignee names the user may wish to select. For instance, it may display a variable value such as “currentuser( )” which will change for different users or fixed values such as unique identifiers of team members of the project, unique identifier of the user creating the query, or unique identifiers of assignees that are selected most often, etc, for example.

At step 406, the client application 222 receives user input. In one example, the client application 222 receives user input when the user submits the input form.

At step 408, the client application 222 generates a create request and communicates this request to the object tracking platform 210 and in particular to the gateway module 211. The create request includes the user input provided in the form (including the filter name, filter query and optionally the filter description, if provided). In addition, the client 222 automatically identifies the board associated with the custom filter create request and adds the identifier of the board (board ID) to the create request. The client 222 also automatically identifies the user making the request (e.g., based on the user's login information) and adds the user identifier (user ID) of the requesting user to the create request. Table A below shows an example of the create request generated by the client application 222 and communicated to the object tracking platform 210 at step 408.

TABLE A
example create request

```
input CreateCustomFilterInput {
  boardId: ID!,
  name: String!,
  jql: String!,
  description: String
}
```

At step 410, the gateway module 211 communicates the request to the board module 212, which receives the request and determines whether the user has permission to make the create request. As noted previously, some user roles may be permitted to create custom filters and other user roles may not be permitted. At step 410, the board module 212 determines whether the user identifier received as part of the create request has permission to create the custom filter. In particular, it may identify the role associated with the user identifier (e.g., by performing a lookup in the permissions database 218) and determine whether the role has permission to create custom filters (e.g., by performing another lookup in the permissions database 218).

If at step 410, the board module 212 determines that the user has permission to create custom filters, the method proceeds to step 412, where the board module 212 determines whether the create request is valid. This step may include one or more checks. For instance, the board module 212 may determine whether the filter query is valid. To this end, the board module 212 may parse the filter query and determine whether the query matches query rules and whether query parameters are valid. For example, if a query includes a project identifier, user identifier, project name, etc., the board module 212 may determine whether any such identifier exists or if it is invalid. In addition, the board module 212 may perform other tests—e.g., it may determine whether the create request includes a filter name and whether the name is unique and not already in use for another saved custom filter for the corresponding board. In some cases, there may be a limit on the number of custom filters that can be created for a board. In such cases, the server application 213 may determine whether the number of custom filters already saved for the board exceeds the preset limit.

If any of these checks fails—e.g., if there is an error in the filter query, the filter name is not unique or the number of filters is already at the limit, the method proceeds to step 414 where the server application generates an error message and communicates this error message to the client system 220. The error message may indicate the type of validation failure, e.g., filter name error, filter query error, description too long, or too many filters, etc. The client application 222 may subsequently display an error message on the client system 220 indicating the type of error. Depending on the error type, the user may be allowed to rectify it. For example, if there is an error in the filter query, the user may edit the filter query and try again. Similarly, if the error is in the filter name, the user may change the filter name and try again. If the error is raised because the number of custom filters is already at limit, the user may try to delete one or more of the custom filters (using method 600) and then retry creation of the custom filter.

Additionally, or altenatively, if all checks pass at step 412, the method proceeds to step 416 where the board module 212 stores the new custom filter in the custom filter database 217. Before storing the custom filter, the board module 212 generates a unique identifier for the custom filter and stores the custom filter against the board identifier of the corresponding board in the custom filter database 217.

Next, the server application 213 communicates a success message to the client system 220 notifying the client 222 that the custom filter has been successfully created. Table B below shows an example of the success message generated by the client application 222.

TABLE B
example success message

statusCode: Int!
success: Boolean!
message: String!
clientMutationId: ID
customFilter: CustomFilterName

The client application 222 can then display a success message to the user to notify the user that the custom filter has been successfully created and stored.

Returning to step 410, if at this step, the board module 212 determines that the user does not have permission to create a custom filter, the method proceeds to step 414 where the board module 212 generates an error message and communicates this message to the client system 220. The method 400 then ends.

### Update Custom Filter

Method 500 shows an example process for updating a custom filter. Method 500 commences at step 502 where the client application 222 receives a request to update a custom filter. In one example, the client application 222 may display the custom filters page 1000, which in addition to showing custom filters, includes an interactive control, such as interactive control 1006, that displays a keyword such as “update”. In some examples, this interactive control may be displayed next to each filter. In other examples, the update interactive control 1006 may be available via a drop down menu associated with each filter (as shown in FIG. 10). In another example, such interactive controls (e.g., see interactive control 1108) may be provided via the board UI 1100. In some examples, such interactive controls may only be displayed on page 1000 or 1100 if the viewing user has permission to update filters. If the viewing user does not have permission to update filters, the user interface may refrain from displaying such interactive controls or may disable the interactivity of these controls.

At step 502, the client application 222 receives user input on an interactive control associated with updating an existing custom filter.

The method then proceeds to step 504, where the client application 222 displays an input form to receive user input to update the custom filter. In some examples, this form may be similar to the input form displayed at step 404. In certain embodiments, the user updating the custom filter may be able to update the following custom filter fields—the filter name, the filter query, and/or the filter description.

At step 506, the client application 222 receives user input. In one example, the client application 222 receives user input when the user submits the input form.

At step 508, the client application 222 generates an update request and communicates this request to the object tracking platform 210 and in particular to the gateway module 211. The update request includes the user input provided in the form (including, e.g., the updated filter name, the updated filter query and/or the updated filter description). In addition, the client 222 automatically identifies the board associated with the custom filter update request and the identifier of the custom filter and adds the identifier of the board and the custom filter to the update request. The client 222 also automatically identifies the user making the request (e.g., based on the user's login information) and adds the user identifier of the requesting user to the update request. Table C below shows an example of the update request generated by the client application 222.

TABLE C
example update request

```
input UpdateCustomFilterInput {
  boardId: ID!,
  customFilterid: ID!,
  filterName: String!,
  filterString: String!,
  filterDescription: String
}
```

At step 510, the gateway module 211 communicates the update request to the board module 212, which receives the update request and determines whether the user has permission to update the custom filter. In particular, the board module 212 determines whether the user identifier received as part of the update request has permission to update the custom filter. This step is similar to step 410 and therefore not described in detail here again.

If at step 510, the board module 212 determines that the user has permission to update the custom filter, the method proceeds to step 512, where the board module 212 determines whether the update request is valid. This step may be similar to step 410 and includes one or more checks. For instance, the board module 212 may determine whether the updated filter query is valid. To this end, the board module 212 may parse the filter query and determine whether the updated query matches query rules and whether query parameters are valid. In addition, the board module 212 may perform other tests—e.g., it may determine whether a filter with that filter identifier exists (this may include a lookup with the filter identifier received in the update request with filter identifiers maintained in the custom filter database 217). Further, if the filter name is updated, it checks whether the updated name is unique and not already in use for another saved custom filter.

If any of these checks fails—e.g., if there is an error in the filter query, the custom filter does not exist or the updated custom filter name is not unique, the method proceeds to step 514 where the board module 212 generates an error message and communicates this error message to the client system 220. The error message may indicate the type of validation failure, e.g., filter does not exist, filter query error, filter name already taken, etc. The client application 222 may subsequently display an error message on the client system 220 indicating the type of error. Depending on the error type, the user may be allowed to rectify it. For example, if there is an error in the filter query, the user may edit the filter query and try again. Similarly, if the error is in the updated filter name, the user may change the filter name and try again.

Additionally, or altenatively, if all checks pass, the method proceeds to step 516 where the board module 212 updates the custom filter as requested. This may include writing over the previous filter name, filter query and/or filter description in the custom filter database 217.

Next, at step 518, the board module 212 communicates a success message to the client system 220 (via the gateway module 211), notifying the client 222 that the custom filter has been successfully updated. The success message may be similar to the message shown in table B. The client application 222 can then display a success message to the user to notify the user that the custom filter has been successfully updated.

Returning to step 510, if at this step, the board module 212 determines that the user does not have permission to update the custom filter, the method proceeds to step 514 where the board module 212 generates an error message and communicates this message to the client system 220. The method 500 then ends.

### Delete Custom Filter

Method 600 shows an example process for deleting a custom filter. Method 600 commences at step 602 where the client application 222 receives a request to delete a custom filter. In one example, the client application 222 may display the custom filter page 1000 that displays, in addition to the one or more custom filters associated with a board, an interactive control 1008 that displays a keyword such as “delete filter,” or just a symbol such as “−” next to the custom filters or in a drop-down menu associated with the custom filter. In some examples, such interactive controls may only be displayed on user interfaces if the viewing user has permission to delete filters. If the viewing user does not have permission to delete filters, the user interface may refrain from displaying such interactive controls or may disable the interactivity of these controls.

At step 602, the client application 222 receives user input on an interactive control associated with deleting an existing custom filter.

The method then proceeds to step 604 where the client application 222 generates a delete request and communicates this request to the object tracking platform 210 and in particular to the gateway module 211. The delete request includes the identifier of the custom filter and the identifier of the corresponding board. The client 222 may also automatically identify the user making the request (e.g., based on the user's login information) and add the user identifier of the requesting user to the delete request. Table D below shows an example of the create request generated by the client application 222.

TABLE D
example delete request

```
input DeleteCustomFilterInput {
  boardId: ID!,
  customFilterId: String!
}
```

At step 606, the gateway module 211 communicates the request to the board module 212, which receives the delete request and determines whether the user has permission to delete the custom filter. This step is similar to steps 410 and 510 and not described again.

If at step 606, the board module 212 determines that the user has permission to delete the custom filter, the method proceeds to step 608, where the board module 212 determines whether the delete request is valid. This step may include determining whether a filter with the filter identifier received in the delete request exists (this may be done by performing a lookup with the filter identifier received in the delete request with filter identifiers maintained in the custom filter database 217).

If at step 608, the board module 212 determines that the delete request is not valid, e.g., because the filter identifier does not exist, the method proceeds to step 610 where the board module 212 generates an error message and communicates this error message to the client system 220. The client application 222 may subsequently display an error message on the client system 220 indicating that the filter cannot be deleted.

Additionally, or alternatively, if the board module 212 determines that the delete request is valid, e.g., because the filter identifier exists, the method proceeds to step 612 where the board module 212 deletes the custom filter. This may include deleting the custom filter record from the custom filter database 217.

Next, at step 614, the board module 212 communicates a success message to the client system notifying the client 222 that the custom filter has been successfully deleted. The success message may be similar to the message shown in table B. The client application 222 can then update the user interface, e.g., by deleting the custom filter that was successfully deleted by the board module 212.

Returning to step 606, if at this step, the board module 212 determines that the user does not have permission to delete the custom filter, the method proceeds to step 610 where the board module 212 generates an error message and communicates this message to the client system 220. The method 600 then ends.

### Retrieve Custom Filters

FIG. 7 is a flowchart illustrating an example method to retrieve custom filters for a displayed board. The method 700 commences at step 702 where the client 222 generates a request to retrieve custom filters. This step may be performed, e.g., when the board UI 1100 is initially loaded or when the custom filters page 1000 is initially loaded. In other embodiments, to reduce any adverse effects of retrieving filters on the critical load time of the UI 1100, the step 702 may be performed when a user wishes to use a custom filter (e.g., when the user interacts with the display element 1104).

In any event, the request includes a board identifier of the board the user is currently viewing and may also include a user identifier of the viewing user.

At step 704, the request to retrieve custom filters is communicated to the server application 213 and in particular to the gateway module 211. The gateway module 211 communicates the request to the board module 212. The board module 212 receives the request and step 706, retrieves custom filters associated with the board from the custom filters database 217. In one example, the board module 212 queries the custom filters database 217 with the board identifier received in the request. The custom filters database 217 returns any custom filters it finds in its database that match the board identifier. In certain embodiments, for each identified filter, the custom filter database 217 returns the filter identifier, the filter name, the filter query, and the filter description (if available). Table E shows an example response received at the board module 212 at step 706.

TABLE E
example response from custom filters database

```
{“data”:
{“boardScope”:
{“customFilters”:[
  {
  “id”:“xxxx”,
  “name”:“Currentuser”,
  “description”:“”,
  “filterQuery”:{“sanitisedJql”:“assignee = currentUser( )”,
  “errors”:[ ]},
  “_{——}typename”:“CustomFilter”
  }
  ],
  “id”:“1”
  }
  },
  “extensions”:
  {
  “gateway”:
  {
  “request_id”:“2c419ad46d3b9cca”,
  “crossRegion”:false,
  “edgeCrossRegion”:false,
  “deprecatedFieldsUsed”:[ ]
  }
  }
  }
]
```

At step 708, the board module 212 communicates this response back to the gateway module 211 which communicates this response back to the client 222 for display.

In some cases, the custom filters may include sensitive information that user may not have permission to view. For example, consider the situation where a user, Mike, has permission to browse or view objects in board A and board B. When viewing board A, he may create a custom filter that is related to the objects in board B (e.g., filter query: board=5d12be1d5a5f2 (unique identifier of board B). After some time, Mike's permissions are updated such that he no longer has browse or view rights for board B. However, Mike can still visit the board UI for board A and view or edit the custom filter, which includes the unique identifier of board B. This may be a privacy concern as Mike should ideally not be able to view the unique identifier of board B. To circumvent such situations, aspects of the present disclosure provide mechanisms to mask private data is custom filters that a user does not have permission to view.

In order to do this, at step 708, instead of communicating the response from the board module 212 to the client 222, the gateway module 211 may be configured to generate and communicate a request to sanitize the received filter queries for the given user to the sanitization module 214. This request may include the filter queries received in the response at step 706 and the user identifier of the user viewing the custom filters.

At step 710, the sanitization module 214 is configured to sanitize the received filter queries. To this end, the sanitization module 214 may parse the received filter queries and determine if any of the filter queries include private data, such as object identifiers, project identifiers, board identifiers, etc. If the sanitization module 214 determines that the received filter queries do not include such private data, the method proceeds to step 712 where the sanitization module 214 returns a message to the gateway module 211 informing the gateway module 211 that the filter queries are sanitized. In some examples, this message may include the unchanged filter queries.

If the sanitization module 214 determines that one or more of the received filter queries include private data, the method proceeds to step 714 where the sanitization module 214 determines whether the user viewing the custom filters has permission to view this private data. To this end, the sanitization module 214 may perform a check in the permissions database 218 to checks whether the user identifier has browse or view access to the private data (e.g., if the private data is an object identifier, a board identifier or a project identifier, the sanitization module 214 determines whether the user has permission to view that object, board or project).

If the sanitization module 214 determines that the user does not have access to the private data, the method proceeds to step 716 the sanitization module 214 masks the private data in the corresponding filter query. In some examples, this may be done by replacing the private data with public data. For example, if the private data is a unique identifier of a board, it may be replaced by the board name. Similarly, if the private data is an object identifier, it may be replaced by the object name.

Then, the method proceeds to step 712, where the sanitization module 214 communicates a sanitization complete message to the gateway module 211 along with the sanitized filter queries. This message may include amended filter queries (if they included private data and the user did not have permission to view the data) and unchanged filter queries (if they did not include private data and/or the user had permission to view the data).

Additionally, or alternatively, if the sanitization module 214 determines that the user has access to the identified private data, the method proceeds to step 712, where the sanitization module 214 communicates a sanitization complete message to the gateway module 211 informing the gateway module 211 that the filter queries are sanitized. In some examples, this message may include the unchanged filter queries.

Once the gateway module 211 receives a response from the sanitization module 214 (including amended or unchanged filter queries), it updates the response received from the board module 212 at step 706 with the sanitized filter queries received from the sanitization module 214 at step 718.

At step 720, the updated custom filter data is communicated to the client 222. In some examples, if the message from the sanitization module 214 includes an indication that none of the filter queries were updated, the gateway module 211 may skip step 718 and directly communicate the response it received from the board module 212 at step 706 to the client 222.

Once the client receives the custom filters, it can update the display (e.g., page 1000 or UI 1100) to show the received custom filters and method 700 ends.

Upon receiving the custom filter data (including e.g., the custom filter identifier, filter name, filter description, and filter query), the client application 222 is configured to store the custom filter data in its local cache 224.

### Apply Custom Filters

FIGS. 8 and 9 are flowcharts illustrating example methods for filtering a board based on selection of a custom filter. Method 800 describes the process at initial load and method 900 describes the process after initial load.

Method 800 commences at step 802, where the gateway module 211 receives a board load request from a client system 220. In some cases, a user may open the object tracking application (e.g., via a web browser or a dedicated application) and select a particular virtual board to be displayed (e.g., by selecting a suitable affordance, icon, tab, or performing a search using a search bar). When this happens, the client application 222 generates a board load request and communicates it to the server application 213. In other cases, the client application may automatically generate and send the board load request to the server application 213, for example, when a user logs into the object tracking application and the home page of the application is a virtual board user interface.

The board load request may include an identifier of the user account of the user that made the request. In some examples, if the user is a registered user of the object tracking application and has logged in before requesting to view a board, the user credentials (e.g., user name or user identifier) is communicated with the board load request. Additionally, or alternatively, if the user is not a registered user of the object tracking application or has not yet logged in, a unique key may be generated for that particular client session and may be communicated to the server application 213 along with the board load request. In addition, the board load request may include a unique identifier associated with the board (i.e., a board identifier) the user wishes to view.

If the user had viewed the board previously and had applied one or more custom filters to the board, information about the applied custom filter (including e.g., the filter identifier, filter name, filter query, etc.) is stored in the local cache 224. Accordingly, at step 802, the client application inspects the local cache 224 and it if determines that one or more custom filters were applied to the board in the last state of the board, identifiers of the identified one or more custom filters are also communicated to the gateway module 211 as part of the board load request. On the other hand, if no filters were previously applied to the board, the board load request does not include any custom filter identifiers.

At step 804, the gateway module 211 fetches object data for the objects present in the requested board. To this end, the gateway module 211 makes a request for board state data to the board module 212. This request includes the board identifier and the user identifier of the user making the request. Upon receiving the request for board state data, the board module 212 is configured to communicate a data request to the data store. The data request includes the combination of the user identifier and board identifier received as part of the request for board state data.

The data store then retrieves board data for the requested board. For example, the DBMS of the main data store may first query the board database 216 for the board state data for the given board identifier. Next, it performs a lookup for the objects present in the board state. It then queries the object database 215 for the object identifiers found in the board state record. Further, the DBMS may query the permissions database 218 to determine whether the user identifier received as part of the data request has permissions to view/edit the object data retrieved from the object database 215. To this end, the DBMS communicates the object identifiers and user identifier to the permissions database 218. The permissions database 218 may then return a list of objects the user is allowed to view and/or edit.

If there are any objects in the board the user is not allowed to view and/or edit, the DBMS removes those objects from the board data and communicates the rest of the board data to the board module 212. In one example, the board data communicated by the main data store to the board module 212 may be similar to the board data shown in the table F below.

TABLE F
Example board data

```
[ari:cloud:jira-software:$cloudId:board/${monolithBoardId.id}/${user.aid}]:
{
  “boardobjects”: {
  “objects”: [
    {
      “id”: 13318,
      “key”: “LI-17”,
      “summary”: “asdf”,
      “objectTypeId”: 10005,
      “estimateValue”: null,
      “estimateText”: null,
      “assigneeId”: null,
      “flagged”: false,
      “statusId”: 10004,
      “parentId”: null,
      “labels”: [ ],
      “isDone”: false,
      “color”: null,
      “childrenIds”: [ ],
      “childrenInfo”: {
        “todoStats”: {
            “objectCount”: 0
        },
        “inProgressStats”: {
          “objectCount”: 0
        },
        “doneStats”: {
          “objectCount”: 0
        },
        “lastColumnObjectStats”: {
          “objectCount”: 0
        }
      },
        “priorityName”: null,
      “priorityUrl”: null,
      “isoDueDate”: null,
      “isoStartDate”: null,
      “fixVersions”: null
    },
    ... other objects
  ],
  “assignees”: [
    {
      “key”: “admin”,
      “name”: “John Doe”,
      “assigneeAccountId”: “38472984723847”,
      “avatarUrl”: “https://secure.gravatar.com/avatar/37462986.png”,
      “hasCustomUserAvatar”: false,
      “autoUserAvatarModel”: null
      },
    ... other assignees
  ]
  },
  “objectParents”: [
  {
    “id”: 13447,
    “key”: “LI-32”,
    “summary”: “my epic 2”,
    “objectTypeId”: 10115,
    “estimateValue”: null,
      “estimateText”: null,
    “assigneeId”: null,
    “flagged”: false,
    “statusId”: 10004,
    “parentId”: null,
    “labels”: [ ],
    “isDone”: false,
    “color”: null,
    “childrenIds”: [
      13456,
      13448,
      13452,
    ],
    “childrenInfo”: {
      “todoStats”: {
        “objectCount”: 3
      },
      “inProgressStats”: {
        “objectCount”: 0
      },
      “doneStats”: {
        “objectCount”: 0
      },
      “lastColumnObjectStats”: {
        “objectCount”: 0
      }
    },
    “priorityName”: null,
    “priorityUrl”: null,
    “isoDueDate”: null,
    “isoStartDate”: null,
    “fixVersions”: null
  }
  ...other object parents
  ],
  “childrenObjects”: {
  “objects”: [ ],
  “assignees”: [ ]
  },
  “clearedObjects”: {
  “hasClearedObjects”: true
  }
}
```

The board module 212 communicates this data to the gateway module 211.

Returning to method 800, at step 806, the gateway module 211 determines whether any custom filters need to be applied to the board. This determination may involve inspecting the board load request to check if it included any custom filter identifiers. If the board load request did not include any custom filter identifiers, the gateway module 211 determines that no custom filters need to be applied to the board. In this case, the method proceeds to step 808 where the gateway module communicates the fetched board data to the client system for rendering a board on the client system and method 800 ends.

Additionally, or alternatively, if the board load request includes custom filter identifiers, the gateway module 211 determines that custom filters need to be applied to the board. In this case, the method proceeds to step 810 where the gateway module communicates the object identifiers of the board fetched at step 804 and the custom filter identifiers received at step 802 to the filtering module 219.

At step 812, the filtering module 219 retrieves the filter queries corresponding to the custom filter identifiers from the custom filter database 217 (e.g., by performing a lookup in the filter database 217 using the custom filter identifiers, and retrieving full records of matching custom filter identifiers).

At step 814, the filtering module 219 applies the retrieved filter queries to the object identifiers of the board received at step 810. Identifiers of objects that match the retrieved filter queries are maintained, while identifiers of objects that do not match the retrieved filter queries are discarded. For example, if the retrieved filter query is objects updated in the last day, the filtering module keeps all objects that were updated in the last day, but discards identifiers of issues that were not updated in the last day.

At step 816, the filtering module 219 returns object identifiers of the filtered results to the gateway module 211.

At step 818, the gateway module 211 uses the filtered object identifiers received from the filtering module 219 to filter the object data received from the board module 212 at step 804. That is, it keeps object data for object identifiers received from the filtering module but discards object data for other objects. This way, the gateway module 211 at step 818 has board data that includes objects that match the previously applied custom filters but does not include any other board objects that do not match the previously applied custom filters.

At step 820, the gateway module 211 communicates the filtered board data to the client application 222 for rendering a board with objects that match the custom filters previously selected. Further, the UI 1100 displayed on the client system 220 may clearly indicate that the data displayed on the board has been filtered based on selection of one or more custom filters (e.g., by highlighting the custom filters that have been applied in the ribbon 1102). Method 800 then ends.

Once the client application 222 receives object data for the board (e.g., at step 808 or step 820), it saves the object data in the local cache 224. In some examples, the stored data for each object includes the data shown in table F that include the object identifier, object name, identifier of user assigned to the object, object description, etc.

In method 800 above, it is presumed that the filters applied to the board are valid. However, in some cases, users may apply a certain custom filter to their board and then close the board. Before the reload the board, it may so happen that an administrator deletes one of the custom filters the user had applied to their board. In this case, the client 222 sends the custom identifier of the deleted custom filter to the gateway module at step 802. At step 812, when the filtering module attempts to retrieve the filter query for that deleted custom filter from the database 217, it determines that the custom filter does not exist. In this case, if no other filters were applied to the board, the filtering module 219 may return an error message to the gateway module 211 after step 812 informing the gateway module 211 that the custom filter does not exist. In this case, the method proceeds to step 808 where unfiltered object data is communicated to the client. If other existing filters were also applied to the board, the filtering module 219 may continue to filter the object IDs based on those filter queries at step 814. However, at step 816, it may also communicate an error message to the gateway module 211 to inform the gateway module 211 that one or more filters were not applied because they did not exist.

Method 900 commences at step 902, where the gateway module 211 receives a request to filter a board from a client system 220. In some cases, a user may be viewing a board (e.g., board 1100) and may select the custom filter drop-down menu 1104 (which invokes method 800) and select a custom filter displayed in the drop-down menu 1104. Upon receiving the user selection, the client application 222 generates a filter request and communicates this request to the gateway module 211.

The filter request includes an identifier of the user account of the user that made the request. In addition, the filter request includes identifiers of the objects currently displayed on the user device, and an identifier of the custom filter selected by the user. The custom filter identifier and object identifiers may be retrieved from the local cache 224.

At step 904, the gateway module 211 communicates the object identifiers and the custom filter identifier received at step 802 to the filtering module 219.

At step 906, the filtering module 219 retrieves the filter query corresponding to the custom filter identifier from the custom filter database 217 (e.g., by performing a lookup in the filter database 217 using the custom filter identifier, and retrieving full record of the matching custom filter identifier).

At step 908, the filtering module 219 applies the retrieved filter queries to the object identifiers received at step 904. Identifiers of objects that match the retrieved filter query are maintained, while identifiers of objects that do not match the retrieved filter queries are discarded. For example, if the retrieved filter query is objects updated in the last day, the filtering module keeps all objects that were updated in the last day, but discards identifiers of issues that were not updated in the last day.

At step 910, the filtering module 219 returns object identifiers of the filtered results to the gateway module 211.

At step 912, the gateway module 211 communicates the object identifiers received from the filtering module 219 to the client application 222 for updating the displayed board. The client application 222 may update its local cache 224 to discard object data for object identifiers that were previously present in the local cache 224 but not in the list of object identifiers received from the gateway module 211. It then updates the displayed board UI 1100 to match the object data maintained in the local cache 224.

Method 900 then ends.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications. For example, in method 600, steps 604 and 606 may be interchanged or combined in a single step.

Unless otherwise stated, the terms “include” and “comprise” (and variations thereof such as “including,” “includes,” “comprising,” “comprises,” “comprised,” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

What is claimed is:

1. A computer-implemented method comprising:
receiving, at a server computer and from a user device, a request for custom filters for a user interface displayed on the user device, the request including an identifier of the user interface displayed on the user device;
retrieving, by the server computer from a data store, custom filter data for one or more custom filters associated with the user interface using the identifier of the user interface, custom filter data for each custom filter comprising a filter identifier and a filter query; and
communicating, to the user device, the one or more custom filters for displaying on the user interface and storing the custom filters in a local cache maintained on the user device.

2. The computer-implemented method of claim 1, wherein the request for the custom filters includes a user identifier of a user viewing the user interface displayed on the user device.

3. The computer-implemented method of claim 2, further comprising:
determining whether the filter query of any of the one or more custom filters includes private data;
upon determining that the filter query of at least one custom filter includes private data, determining whether the user viewing the user interface has permission to view the private data based on the user identifier of the user viewing the user interface; and
masking the private data in the filter query to generate a sanitized filter query upon determining that the user viewing the user interface does not have permission to view the private data.

4. The computer-implemented method of claim 3, further comprising updating the custom filter data of the at least one custom filter using the sanitized filter query before communicating the one or more custom filters to the user device.

5. The computer-implemented method of claim 1, further comprising:
receiving, at the server computer, a custom filter request, the filter request including a filter identifier of a selected custom filter, and object identifiers of one or more objects displayed on the user interface;
retrieving, from the data store, the filter query for the selected custom filter using the received filter identifier;
filtering the object identifiers of the one or more objects displayed on the user interface using the filter query; and
communicating an output of the filtering step to the user device to display on the user interface.

6. The computer-implemented method of claim 5, wherein the output of the filtering step includes an identifier of at least one object that matches the filter query; and
communicating the output to the user device includes communicating the identifier of the at least one object to the user device, and the user device replacing the one or more objects previously displayed on the user interface with the at least one object.

7. The computer-implemented method of claim 5, wherein:
none of the object identifiers of the one or more objects displayed on the user interface match the filter query;
the output of the filtering step includes a message indicating that none of the object identifiers of the one or more objects displayed on the user interface match the filter query; and
the user device removes the one or more objects previously displayed on the user interface.

8. A system, comprising:
a processing unit;
a communication interface;
a non-transitory computer-readable storage media comprising instructions which, when executed by the processing unit, cause the processing unit to:
receive a request for custom filters, from a user device, for a user interface displayed on the user device, the request including an identifier of the user interface displayed on the user device;
retrieve, from a data store, custom filter data for one or more custom filters associated with the user interface using the identifier of the user interface, custom filter data for each custom filter comprising a filter identifier and a filter query; and
communicate the one or more custom filters to the user device, the user device displaying the one or more custom filters on the user interface and storing the custom filters in a local cache maintained on the user device.

9. The system of claim 8, wherein the request for the custom filters includes a user identifier of a user viewing the user interface displayed on the user device.

10. The system of claim 9, wherein the non-transitory computer-readable storage media further comprising instructions which, when executed by the processing unit, cause the processing unit to:
determine whether the filter query of any of the one or more custom filters includes private data;
upon determining that the filter query of at least one custom filter includes private data, determine whether the user viewing the user interface has permission to view the private data based on the user identifier of the user viewing the user interface; and
mask the private data in the filter query to generate a sanitized filter query upon determining that the user viewing the user interface does not have permission to view the private data.

11. The system of claim 10, wherein the non-transitory computer-readable storage media further comprising instructions which, when executed by the processing unit, cause the processing unit to update the custom filter data of the at least one custom filter using the sanitized filter query before communicating the one or more custom filters to the user device.

12. The system of claim 8, wherein the non-transitory computer-readable storage media further comprising instructions which, when executed by the processing unit, cause the processing unit to:
receive a custom filter request, the filter request including a filter identifier of a selected custom filter, and object identifiers of one or more objects displayed on the user interface;
retrieve, from the data store, the filter query for the selected custom filter using the received filter identifier;
filter the object identifiers of the one or more objects displayed on the user interface using the filter query; and
communicate an output of the filtering step to the user device to display on the user interface.

13. The system of claim 12, wherein:
the output of the filtering step includes an identifier of at least one object that matches the filter query;
communicating the output to the user device includes communicating the identifier of the at least one object to the user device; and
the user device replaces the one or more objects previously displayed on the user interface with the at least one object.

14. The system of claim 12, wherein:
none of the object identifiers of the one or more objects displayed on the user interface match the filter query;
the output of the filtering step includes a message indicating that none of the object identifiers of the one or more objects displayed on the user interface match the filter query; and
the user device removes the one or more objects previously displayed on the user interface.

15. A non-transitory computer-readable storage media comprising instructions which, when executed by a processing unit, cause the processing unit to:
receive, from a user device, a request for custom filters for a user interface displayed on the user device, the request including an identifier of the user interface displayed on the user device;
retrieve, from a data store, custom filter data for one or more custom filters associated with the user interface using the identifier of the user interface, custom filter data for each custom filter comprising a filter identifier and a filter query; and
communicate the one or more custom filters to the user device, the user device displaying the one or more custom filters on the user interface and storing the custom filters in a local cache maintained on the user device.

16. The non-transitory computer-readable storage media of claim 15, wherein the request for the custom filters includes a user identifier of a user viewing the user interface displayed on the user device.

17. The non-transitory computer-readable storage media of claim 16, further comprising instructions which, when executed by the processing unit, cause the processing unit to:
determine whether the filter query of any of the one or more custom filters includes private data;
upon determining that the filter query of at least one custom filter includes private data, determine whether the user viewing the user interface has permission to view the private data based on the user identifier of the user viewing the user interface; and
mask the private data in the filter query to generate a sanitized filter query upon determining that the user viewing the user interface does not have permission to view the private data.

18. The non-transitory computer-readable storage media of claim 17, further comprising instructions which, when executed by the processing unit, cause the processing unit to update the custom filter data of the at least one custom filter using the sanitized filter query before communicating the one or more custom filters to the user device.

19. The non-transitory computer-readable storage media of claim 15, further comprising instructions which, when executed by the processing unit, cause the processing unit to:
receive a custom filter request, the filter request including a filter identifier of a selected custom filter, and object identifiers of one or more objects displayed on the user interface;
retrieve, from the data store, the filter query for the selected custom filter using the received filter identifier;
filter the object identifiers of the one or more objects displayed on the user interface using the filter query; and
communicate an output of the filtering step to the user device to display on the user interface.

20. The non-transitory computer-readable storage media of claim 19, wherein:
the output of the filtering step includes an identifier of at least one object that matches the filter query;
communicating the output to the user device includes communicating the identifier of the at least one object to the user device; and
the user device replaces the one or more objects previously displayed on the user interface with the at least one object.
